(19) United States
(12) Patent Application Publication
(10) Pub. No.: US 2024/0339666 A1
(43) Pub. Date: Oct. 10, 2024

(54) LITHIUM SECONDARY BATTERY

(71) Applicant: SK ON CO., LTD., Seoul (KR)

(72) Inventors: Jae Yeong LEE, Daejeon (KR); Jae Ram KIM, Daejeon (KR); Ji Won NA, Daejeon (KR); Sang Won BAE, Daejeon (KR); Ji Hee BAE, Daejeon (KR); Yeon Hwa SONG, Daejeon (KR); Ki Joo EOM, Daejeon (KR); Myung Ro LEE, Daejeon (KR); Yong Seok LEE, Daejeon (KR); Hyun Joong JANG, Daejeon (KR)

(21) Appl. No.: 18/623,031

(22) Filed: Apr. 1, 2024

(30) Foreign Application Priority Data
Apr. 7, 2023 (KR) 10-2023-0046250

(51) Int. Cl. H01M 10/0569; H01M 4/131; H01M 4/133; H01M 4/525; H01M 4/587; H01M 10/052; H01M 10/0568

(52) U.S. Cl. CPC H01M 10/0569; H01M 4/131; H01M 4/133; H01M 4/525; H01M 4/587; H01M 10/052; H01M 10/0568; H01M 2300/004

(57) ABSTRACT

A lithium secondary battery includes a cathode including a cathode active material that includes a lithium metal oxide, an anode facing the cathode and including an anode electrode active material that includes a graphite-based active material and a silicon-carbon composite, and an electrolyte solution including a lithium salt and an organic solvent, the lithium salt including lithium bis(fluorosulfonyl)imide (LiFSI) and the organic solvent including an acetate-based solvent. A content of the silicon-carbon composite is in a range from 5 wt % to 12 wt % based on a total weight of the anode active material.

### CROSS-REFERENCE TO RELATED APPLICATION AND CLAIM OF PRIORITY

This application claims priority to Korean Patent Application No. 10-2023-0046250 filed on Apr. 7, 2023 in the Korean Intellectual Property Office (KIPO), the entire disclosure of which is incorporated by reference herein.

### BACKGROUND

### 1. Field

The present disclosure relates to a lithium secondary battery. The present disclosure relates to a lithium secondary battery including an electrode assembly and electrolyte solution.

### 2. Description of the Related Art

A secondary battery which can be charged and discharged repeatedly has been widely employed as a power source of a mobile electronic device such as a camcorder, a mobile phone, a laptop computer, etc., according to developments of information and display technologies. Recently, a battery pack including the secondary battery is being developed and applied as a power source of an eco-friendly vehicle.

A lithium secondary battery is being actively developed and applied due to high operational voltage and energy density per unit weight, a high charging rate, a compact dimension, etc.

For example, the lithium secondary battery may include an electrode assembly including a cathode, an anode and a separation layer (separator), and an electrolyte immersing the electrode assembly. The lithium secondary battery may further include an outer case having, e.g., a pouch shape accommodating the electrode assembly and the electrolyte.

If the lithium secondary battery is applied to an electric vehicle, high capacity, rapid charging, extended life-span properties may be needed. The rapid charging properties of the lithium secondary battery may increase as, e.g., a conductivity of lithium ions through the electrode, the separator and/or the electrolyte solution increases.

When the rapid charging and discharging of the lithium secondary battery are repeated, an electrode resistance may increase due to a lithium salt deposited at an interface between the electrode and the electrolyte solution or by-products due to a side reaction between an electrode active material and the electrolyte solution. As a charging and discharging cycle of the lithium secondary battery is repeated, the capacity may be decreased.

If a non-aqueous electrolyte solution is used, a cell swelling may occur due to a gas generation during the rapid charging with a high constant current, or charging efficiency may be lowered. Accordingly, lithium may be deposited from the anode, high-temperature storage properties of the secondary battery may be deteriorated SUMMARY

According to an aspect of the present invention, there is provided a lithium secondary battery having improved rapid-charging property.

A lithium secondary battery includes a cathode including a cathode active material that includes a lithium metal oxide, an anode facing the cathode and including an anode electrode active material that includes a graphite-based active material and a silicon-carbon composite, and an electrolyte solution including a lithium salt and an organic solvent, the lithium salt including lithium bis(fluorosulfonyl)imide (LiFSI) and the organic solvent including an acetate-based solvent. A content of the silicon-carbon composite is in a range from 5 wt % to 12 wt % based on a total weight of the anode active material.

In some embodiments, the content of the silicon-carbon composite may be in a range from 7 wt % to 11 wt % based on the total weight of the anode active material

In some embodiments, the silicon-carbon composite may include SiC.

In some embodiments, a weight ratio of the graphite-based active material and the silicon-carbon composite may be in a range from 88:12 to 95:5.

In some embodiments, the graphite-based active material may include natural graphite or artificial graphite.

In some embodiments, a concentration of LiFSI in the electrolyte solution may be in a range from 0.1 M to 1.0 M.

In some embodiments, a concentration of LiFSI in the electrolyte solution may be in a range from 0.6 M to 0.9 M.

In some embodiments, a content of the acetate-based solvent may be in a range from 5 vol % to 20 vol % based on a total volume of the organic solvent.

In some embodiments, a lithium salt may further include lithium hexafluorophosphate (LiPF₆).

In some embodiments, a molar concentration of LiPF₆ in the electrolyte solution may be in a range from 0.1 M to 1.0 M.

In some embodiments, a molar concentration ratio of LiFSI and LiPF₆ in the electrolyte solution may be in a range from 1:0.5 to 1:3.

In some embodiments, the acetate-based solvent includes methyl acetate, ethyl acetate and/or propyl acetate.

In some embodiments, the organic solvent may further include at least one carbonate-based solvent that may include propylene carbonate, ethylene carbonate, diethyl carbonate, dimethyl carbonate, ethylmethyl carbonate, methylpropyl carbonate, dipropyl carbonate and/or vinylene carbonate.

In some embodiments, the electrolyte solution may further include at least one additive that may include a carbonate-based compound substituted with a halogen group, a sulfone-based compound, a sulfite-based compound, a sulfonate-based compound, a sultone-based compound and/or a sulfate-based compound.

In some embodiments, the cathode active material may include a lithium-nickel metal oxide containing 80 mol % or more of nickel of all elements excluding lithium and oxygen.

In some embodiments, the lithium secondary battery may further include a separator interposed between the cathode and the anode.

A lithium secondary battery according to embodiments of the present disclosure has improved capacity and rapid charging properties. Even during repeated rapid charging and discharging of the lithium secondary battery, reduction of a battery capacity may be suppressed and rapid charging life-span properties may be improved.

According to embodiments of the present disclosure, an electrolyte solution includes LiFSI and an acetate-based solvent, and may have a low viscosity. Accordingly, a lithium ion conductivity in the electrolyte solution may be increased, and the rapid charging properties of the lithium secondary battery may be improved.

In some embodiments, an anode active material includes a silicon-carbon composite, and a high-capacity lithium secondary battery may be more effectively implemented.

### BRIEF DESCRIPTION OF THE DRAWINGS

FIG. 1 is a schematic plane projection view illustrating a lithium secondary battery in accordance with example embodiments.

FIG. 2 is a schematic cross-sectional view illustrating a lithium secondary battery in accordance with example embodiments.

FIG. 3 is a graph showing a rapid charging/discharging capacity retention according to cycles of Example 1, Example 2, Comparative Example 1 and Comparative Example 2.

FIG. 4 is a graph showing reference performance test (RPT) results according to cycles of Example 1, Example 2, Comparative Example 1 and Comparative Example 2.

FIG. 5 is a graph showing a rapid charging/discharging capacity retention according to cycles of Example 1 and Comparative Example 3.

FIG. 6 is a graph showing 35-minute rapid charging RPT results according to cycles of Example 1 and Comparative Example 3.

### DETAILED DESCRIPTION OF THE EMBODIMENTS

According to embodiments of the present disclosure, a lithium secondary battery having improved charging properties and high capacity is provided.

Hereinafter, embodiments of the present disclosure will be described in detail. However, those skilled in the art will appreciate that such embodiments are provided to further understand the spirit of the present inventive concepts do not limit the subject matters to be protected as disclosed in the detailed description and appended claims.

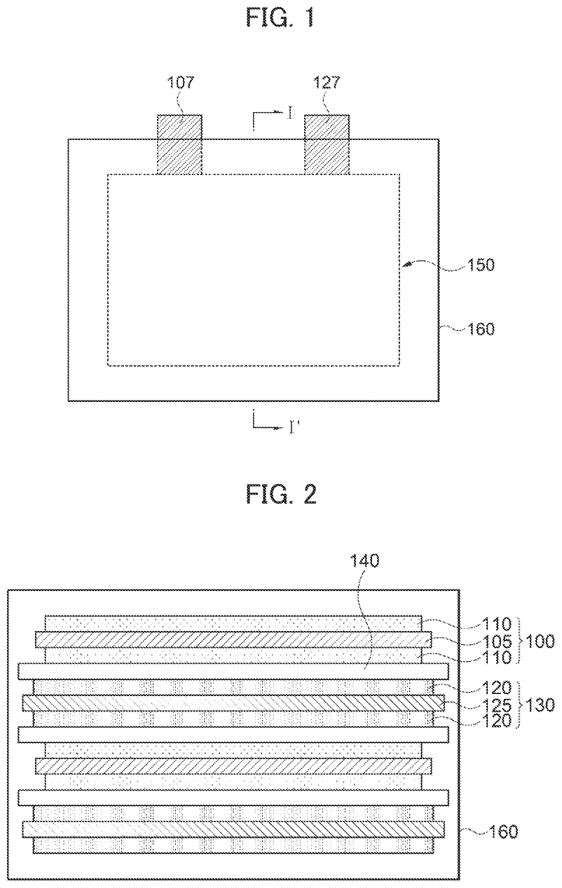

FIG. 1 is a schematic plan projection view illustrating a lithium secondary battery in accordance with example embodiments. FIG. 2 is a schematic cross-sectional view illustrating a lithium secondary battery in accordance with example embodiments. For example, FIG. 2 is a cross-sectional view taken along a line I-I′ of FIG. 1 in a thickness direction.

Referring to FIGS. 1 and 2, a lithium secondary battery may include an anode 130, a cathode 100 opposing the anode 130, and an electrolyte solution (not illustrated).

In example embodiments, the anode 130 may include an anode active material layer. For example, the anode 130 may include an anode active material layer 120 on at least one surface of an anode current collector 125.

In example embodiments, the anode active material layer 120 may include an anode active material. The anode active material may include a graphite-based active material and a silicon-carbon composite.

A content of the silicon-carbon composite based on a total weight of the anode active material may be in a range from 5 weight percent (wt %) to 12 wt %. In an embodiment, the content of the silicon-carbon composite based on the total weight of the anode active material may be in a range from 7 wt % to 11 wt %. Within the above content range, a capacity of the lithium secondary battery may be increased while maintaining stability.

If the content of the silicon-carbon composite is less than 5 wt %, the capacity of the lithium secondary battery may not be sufficiently increased. If the content of the silicon-carbon composite exceeds 12 wt %, the anode active material layer may be repeatedly expanded and contracted to cause electrode damages.

In example embodiments, the silicon-carbon composite may include a silicon element and a carbon element.

In an embodiment, the silicon-carbon composite may include silicon and/or a silicon-containing alloy within a porous carbon-based matrix.

In an embodiment, the silicon-carbon composite may have a core-shell structure and may include a carbon-based core and a silicon-based shell, or may include a silicon-based core and a carbon-based shell.

In an embodiment, the silicon-carbon composite may include a silicon-carbon compound. For example, the silicon-carbon composite may include SiC (silicon carbide).

In example embodiments, the graphite-based active material may include artificial graphite or natural graphite. When the graphite-based active material includes natural graphite and artificial graphite, a weight of natural graphite may be greater than a weight of artificial graphite in the graphite-based active material. Accordingly, the capacity of the lithium secondary battery may be more increased.

In example embodiments, a weight ratio of the graphite-based active material and the silicon-carbon composite may be in a range from 88:12 to 95:5. In an embodiment, the weight ratio of the graphite-based active material and the silicon-carbon composite may be in a range from 89:11 to 93:7.

In the above range of the weight ratio, the lithium secondary battery having higher capacity and improved stability may be implemented compared to that from the case that the anode active material contains only the carbon-based active material.

In example embodiments, the anode active material layer 120 may further include other active materials. The other active materials may include, e.g., a lithium alloy.

For example, the lithium alloy may include a metal different from lithium forming an alloy with lithium. Examples of the different metal include aluminum, zinc, bismuth, cadmium, antimony, silicon, lead, tin, gallium, indium, etc. These may be used alone or in a combination of two or more therefrom.

For example, the anode active material, an anode binder, a conductive material, a dispersive medium, etc., may be mixed and stirred to prepare an anode slurry. The anode slurry may be coated on the anode current collector, and then dried and pressed to form the anode 130.

For example, the anode current collector may include gold, stainless steel, nickel, aluminum, titanium, copper or an alloy thereof, and may include, e.g., copper or a copper alloy.

For example, the anode binder may include an organic binder such as polyvinylidene fluoride (PVDF), vinylidene fluoride-hexafluoropropylene copolymer (PVDF-co-HFP), polyacrylonitrile, polymethylmethacrylate, etc.; an aqueous binder such as styrene-butadiene rubber (SBR). The anode binder may be used with a thickener such as carboxymethyl cellulose (CMC).

For example, the conductive material may include a carbon-based conductive material such as graphite, carbon black, graphene, a carbon nanotube, etc.; a metal-based conductive material such as tin, tin oxide, titanium oxide, a perovskite materials containing, e.g., LaSrCoO₃, LaSrMnO₃, etc.

According to embodiments, the cathode 100 may include a cathode active material layer 110. For example, the cathode 100 may include a cathode active material layer 110 on at least one surface of a cathode current collector 105.

In example embodiments, the cathode active material layer 110 may include a cathode active material. For example, the cathode active material may include a lithium metal oxide capable of reversibly intercalating and de-intercalating lithium ions.

The cathode active material may include a lithium-nickel metal oxide containing 80 mol % or more of nickel among all elements except lithium and oxygen.

In example embodiments, the lithium-nickel metal oxide may include at least one of Co, Al and Mn.

In some embodiments, the lithium-nickel metal oxide may be represented by Chemical Formula below.

LiₓNi_{(1-a-b)}CoₐM_{b}O_{y} [Chemical Formula]

In Chemical Formula, M may include at least one of Al, Zr, Ti, Cr, B, Mg, Mn, Ba, Si, Y, W and Sr, 0.9≤x≤1.2, 1.9≤y≤2.1, and 0≤a+b≤0.2.

In some embodiments, 0<a+b≤0.1 in Chemical Formula.

In example embodiments, the cathode active material layer 110 may further include a cathode binder and a conductive material.

For example, a cathode slurry may be prepared by mixing and stirring the cathode active material, the cathode binder, the conductive material and a dispersion medium. The cathode slurry may be coated on a cathode current collector 105, and then dried and coated to form the cathode 100.

The cathode binder and the conductive material may include materials substantially the same as or similar to the anode binder and the conductive material for the abode as described above. For example, the cathode binder may include an organic binder such as polyvinylidene fluoride (PVDF). The cathode binder may be used together with a thickener such as, e.g., carboxymethyl cellulose (CMC).

For example, the cathode current collector 105 may include stainless steel, nickel, aluminum, titanium, copper or an alloy thereof.

In some embodiments, an area of the anode 130 may be larger than an area of the cathode 100. In this case, lithium ions generated from the cathode 100 may be easily transferred to the anode 130 without being precipitated.

In example embodiments, According to example embodiments, a separator 140 may be interposed between the cathode 100 and the anode 130.

The separator 140 may include a porous polymer film prepared from, e.g., a polyolefin-based polymer such as an ethylene homopolymer, a propylene homopolymer, an ethylene/butene copolymer, an ethylene/hexene copolymer, an ethylene/methacrylate copolymer, or the like. The separator 140 may also include a non-woven fabric formed from a glass fiber with a high melting point, a polyethylene terephthalate fiber, etc.

In example embodiments, an electrode cell may be defined by the cathode 100, the anode 130 and the separator 140, and a plurality of the electrode cells may be stacked to form an electrode assembly 150. For example, the electrode assembly 150 may be formed by winding, stacking or z-folding of the separator 140.

The lithium secondary battery according to embodiments of the present disclosure may include an electrolyte solution. For example, the electrode assembly 150 and the electrolyte solution may be accommodated together in a case 160 to form the lithium secondary battery.

In example embodiments, the electrolyte solution may be a non-aqueous electrolyte solution. The electrolyte solution may include a lithium salt serving as an electrolyte.

The lithium salt may include lithium bis(fluorosulfonyl)imide (LiFSI), or may include LiFSI and lithium hexafluorophosphate (LiPF₆). LiFSI may be represented by Li⁺(SO₂F)₂N⁻, and LiPF₆ may be represented by Li⁺PF₆⁻.

The electrolyte solution may include LiFSI in a concentration from 0.1 M to 1.0 M. In some embodiments, the electrolyte solution may include LiFSI in a concentration from 0.5 M to 1.0 M, from 0.6 M to 0.9 M, or from 0.7 M to 0.8 M. In the above concentration range of LiFSI at a concentration within the above range, a lithium ion conductivity may be enhanced, and rapid charging properties of the lithium secondary battery may be improved.

If the concentration of LiFSI exceeds 1.0 M, stability of the electrolyte solution may be lowered, a swelling of the battery may be caused during an operation of the lithium secondary battery.

If the concentration of LiFSI is less than 0.1 M, the lithium ion conductivity may be lowered, and the rapid charging life-span properties of the lithium secondary battery may be degraded.

In example embodiments, the electrolyte solution may include LiPF6 in a concentration from 0.1 M to 1.0 M. In some embodiments, the electrolyte solution may include LiPF₆ in a concentration from 0.3 M to 0.7 M, or from 0.5 M to 0.6 M.

According to embodiments, a molar concentration ratio of LiFSI and LiPF₆ in the electrolyte solution may be in a range from 1:0.5 to 1:3. In some embodiments, the molar concentration ratio of LiFSI and LiPF₆ in the electrolyte solution may be in a range from 1:0.7 to 1:2, or from 1:0.9 to 1:1.2.

The contents of LiFSI and LiPF₆ may be adjusted to have the molar concentration ratio in the above range, the lithium secondary battery may have higher lithium ion conductivity and side reactions with the electrode active material may be suppressed, thereby also improving rapid charging performance and life-span properties.

If the molar concentration ratio of LiFSI and LiPF₆ in the electrolyte solution is less than 1:0.5, electrochemical stability of the electrolyte solution may be degraded, and the side reaction with the anode active material or the cathode active material may easily occur.

If the molar concentration ratio of LiFSI and LiPF₆ in the electrolyte is greater than 1:3, the lithium ion conductivity of the electrolyte solution may be degraded, and the rapid charging performance and rapid charging life-span properties of the lithium secondary battery may also be degraded.

In example embodiments, the lithium salt may further include a compound represented by, e.g., Li⁺X⁻. An anion X⁻ of the lithium salt may include F⁻, Cl⁻, Br⁻, I⁻, NO₃⁻, N(CN)₂⁻, BF₄⁻, ClO₄⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, etc.

The electrolyte solution includes an acetate-based solvent. The electrolyte solution may include the acetate-based solvent in an amount from 5 volume percent (vol %) to 20 vol % based on a total volume of the electrolyte solution. In some embodiments, the electrolyte solution may include the acetate-based solvent in an amount from 5 vol % to 15 vol %, or from 5 vol % to 10 vol % based on the total volume of the electrolyte solution.

In the content range of the acetate-based solvent within the above range, a polarity of the electrolyte solution may be enhanced to improve permeability of the electrode and the separator. Further, the lithium ion conductivity may be improved to further increase a charging rate of the lithium secondary battery.

Additionally, a reactivity of the electrolyte solution with the anode active material and the cathode active material may be reduced to suppress the side reactions

If the content of the acetate-based solvent is less than 5 vol %, the capacity or the charging rate of the battery may be lowered during repeated rapid charging and discharging of the lithium secondary battery.

If the content of the acetate-based solvent exceeds 20 vol %, the lithium ion conductivity of the electrolyte solution may be degraded, and the rapid charging properties of the lithium secondary battery may be lowered.

In example embodiments, the acetate-based solvent may include at least one selected from the group consisting of methyl acetate (MA), ethyl acetate (EA), and propyl acetate (PA). In an embodiment, the acetate-based solvent may include ethyl acetate.

In example embodiments, the electrolyte solution may further include a carbonate-based solvent. The carbonate-based solvent may include propylene carbonate (PC), ethylene carbonate (EC), diethyl carbonate (DEC), dimethyl carbonate (DMC), ethylmethyl carbonate (EMC), methylpropyl carbonate, dipropyl carbonate, vinylene carbonate, etc. These may be used alone or in a combination of two or more therefrom.

In example embodiments, the electrolyte solution may further include at least one additive selected from the group consisting of a carbonate-based compound substituted with a halogen group, a sulfone-based compound, a sulfite-based compound, a sulfonate-based compound, a sultone-based compound and a sulfate-based compound.

The carbonate-based compound substituted with a halogen group may include fluoroethylene carbonate (FEC).

The sulfone-based compound may include dimethyl sulfone, diethyl sulfone, ethyl methyl sulfone, methyl vinyl sulfone, divinyl sulfone, etc.

The sulfite-based compound may include ethylene sulfite, methyl ethylene sulfite, ethyl ethylene sulfite, 4,5-dimethyl ethylene sulfite, 4,5-diethyl ethylene sulfite, propylene sulfite, 4,5-dimethyl propylene sulfite, 4,5-diethyl propylene sulfite, 4,6-dimethyl propylene sulfite, 4,6-diethyl propylene sulfite, 1,3-butylene glycol sulfite, etc.

The sulfonate-based compound may include methyl methanesulfonate, ethyl methanesulfonate, methyl ethanesulfonate, propyl methanesulfonate, methyl propanesulfonate, ethyl propanesulfonate, vinyl methanesulfonate, allyl methanesulfonate, vinyl benzenesulfonate, allyl prop-2-ensulfonate, etc.

The sultone-based compound may include 1,3-propane sultone, 1,3-propene sultone, 1,4-butane sultone, etc.

The sulfate-based compound may include 1,2-ethylene sulfate, 1,2-propylene sulfate, 2,3-butylene sulfate, 1,3-propylene sulfate, 1,3-butylene sulfate, etc.

The above-mentioned additives may be used alone or in a combination of two or more therefrom.

A content of the additive may be adjusted within a range that does not inhibit the operation of the electrolyte solution. For example, the content of the additive may be in a range from about 0.01 wt % to 10 wt % based on the total weight of the electrolyte solution.

The lithium secondary battery may be manufactured in, e.g., a cylindrical shape, a prismatic shape, a pouch shape, a coin shape, etc.

The lithium secondary battery may include electrode leads 107 and 127 being connected to the electrodes 100 and 130 and protruding to the outside of the case 160. The electrode leads 107 and 127 may include a cathode lead 107 being connected to the cathode 100 and protruding to the outside of the case 160, and an anode electrode lead 127 being connected to the anode 130 and protruding to the outside of the case 160.

For example, the cathode lead 107 may be electrically connected to the cathode current collector 105. The anode lead 127 may be electrically connected to the anode current collector 125.

Each of the cathode current collector 105 of the cathode 100 and the anode current collector 125 of the anode 130 may include a notched portion. The notched portion may serve as, e.g., an electrode tab. The notched portion may include a cathode notched portion protruding from the cathode current collector 105 and an anode notched portion protruding from the anode current collector 125.

For example, the cathode current collector 105 may include a protrusion (a cathode tab) at one side thereof. The cathode active material layer 110 may not be formed on the cathode tab. The cathode tab may be integrally formed with the cathode current collector 105 or may be connected by welding. The cathode current collector 105 and the cathode lead 107 may be electrically connected through the cathode tab.

The anode current collector 125 may include a protrusion (an anode tab) at one side thereof. The anode active material layer 120 may not be formed on the anode tab. The anode tab may be integrally formed with the anode current collector 125 or may be connected by welding. The anode current collector 125 and the anode lead 127 may be electrically connected through the anode tab.

The electrode assembly 150 may include a plurality of the cathodes and a plurality of the anodes. For example, a plurality of the cathodes and a plurality of the anodes may be alternately stacked, and the separator may be interposed between the cathode and the anode.

Accordingly, the lithium secondary battery may include the cathode tabs protruding from each of the plurality of the cathodes and the anode tabs protruding from each of the plurality of the anodes.

The cathode tabs (or the anode tabs) may be stacked, pressed, and welded to form a cathode tab stack (or the anode tab stack). The cathode tab stack may be electrically connected to the cathode lead 107. The anode tab stack may be electrically connected to the anode lead 127.

Hereinafter, experimental examples are proposed to more concretely describe embodiments of the present disclosure. However, the following examples are only given for illustrating the present disclosure and those skilled in the related art will obviously understand that various alterations and modifications are possible within the scope and spirit of the present disclosure. Such alterations and modifications are duly included in the appended claims.

### Example 1

An anode slurry was prepared by adding water to 0.25 parts by weight of a SWCNT conductive material and 3.60 parts by weight of a CMC/SBR (binder, 1.20/2.40 weight ratio) based on 100 parts by weight of an anode active material including 89 parts by weight of natural graphite (D50: 20 km) and 11 parts by weight of SiC.

The anode slurry was coated, dried and pressed on one surface of a copper current collector (copper foil with a thickness of 8 km) to form an anode active material layer and obtain an anode.

An cathode slurry was prepared by mixing Li[Ni_{0.88}Co_{0.1}Mn_{0.02}]O₂ as a cathode active material, MWCNTs as a conductive material, and polyvinylidene fluoride (PVDF) as a binder in a weight ratio of 98.08:0.72:1.2. The slurry was uniformly coated on an aluminum foil having a thickness of 12 μm, and dried under a vacuum condition to prepare a cathode for a secondary battery. About 20 wt % of the MWCNT content was used as a CNT dispersive agent.

The cathode and the anode were notched in a predetermined sized, and stacked with a separator (polyethylene, thickness 13 μm) interposed therebetween to form an electrode cell. Tab portions of the cathode and the anode were welded. The welded assembly of the cathode/separator/anode was placed in a pouch, and three sides were sealed except for an electrolyte injection side. The tab portions were included in the sealing portion. An electrolyte solution was injected through the electrolyte injection side, and the electrolyte injection side was also sealed and impregnated for 12 hours or more.

In the preparation of the electrolyte solution, 0.5M LiFSI and 0.6M LiPF₆ were dissolved in a mixed solvent of ethyl carbonate, ethyl methyl carbonate and ethyl acetate (EC/EMC/EA=25/70/5, volume ratio), 8 wt % of fluoroethylene carbonate (FEC), 0.5 wt % of 1,3-propensultone (PRS), and 1.0 wt % of 1,3-propanesultone (PS) were added.

### Example 2

A lithium secondary battery was manufactured by the same method as that in Example 1, except that the electrolyte solution was prepared to include 0.7 M of LiFSI and 0.4 M of LiPF₆.

### Comparative Example 1

A lithium secondary battery was manufactured by the same method as that in Example 1, except that the electrolyte solution was prepared using a mixed solvent of EC/EMC (25/75, volume ratio).

### Comparative Example 2

A lithium secondary battery was manufactured by the same method as that in Example 1, except that the electrolyte solution was prepared to include 1.1 M of LiPF₆ and to be devoid of EA and LiFSI.

### Comparative Example 3

A lithium secondary battery was manufactured by the same method as that in Example 1, except that the anode active material included 87 wt % of natural graphite (D50: 20 μm) and 13 wt % of SiC.

Table 1 below shows the constructions of the lithium secondary batteries of Examples 1 to 2 and Comparative Examples 1 to 3.

TABLE 1

| | anode active material | electrolyte solution | |
|---|---|---|---|
| | SiC:natural graphite | solvent | |
| | (weight ratio) | (volume ratio) | lithium salt |
| Example 1 | 11:89 | EC/EMC/EA | 0.5M LiFSI, |
| | | (25/70/5) | 0.6M LiPF₆ |
| Example 2 | 11:89 | EC/EMC/EA | 0.7M LiFSI, |
| | | (25/70/5) | 0.4M LiPF₆ |
| Comparative | 11:89 | EC/EMC | 0.5M LiFSI, |
| Example 1 | | (25/75) | 0.6M LiPF₆ |
| Comparative | 11:89 | EC/EMC | 1.1M LiPF₆ |
| Example 2 | | (25/75) | |
| Comparative | 13:87 | EC/EMC/EA | 0.5M LiFSI, |
| Example 3 | | (25/70/5) | 0.6M LiPF₆ |

### Experimental Example

In the lithium secondary batteries of Example 1 and Comparative Example 1, a constant voltage charging was performed at 25° C. to reach a state of SOC82 within 35 minutes, and a constant current discharging (SOC10 CC cut-off) was performed at 0.3 C to reach a state of SOC 10. Further, a reference performance test (RPT) was performed every 100 cycles.

In the RPT, a 4.2V constant voltage charging was performed, and the charging was stopper when reaching a current limit of C/100. Thereafter, a constant current discharging was performed until reaching a lower limit voltage of 2.5 V. The discharging process was performed with a C-rate of 0.3 C.

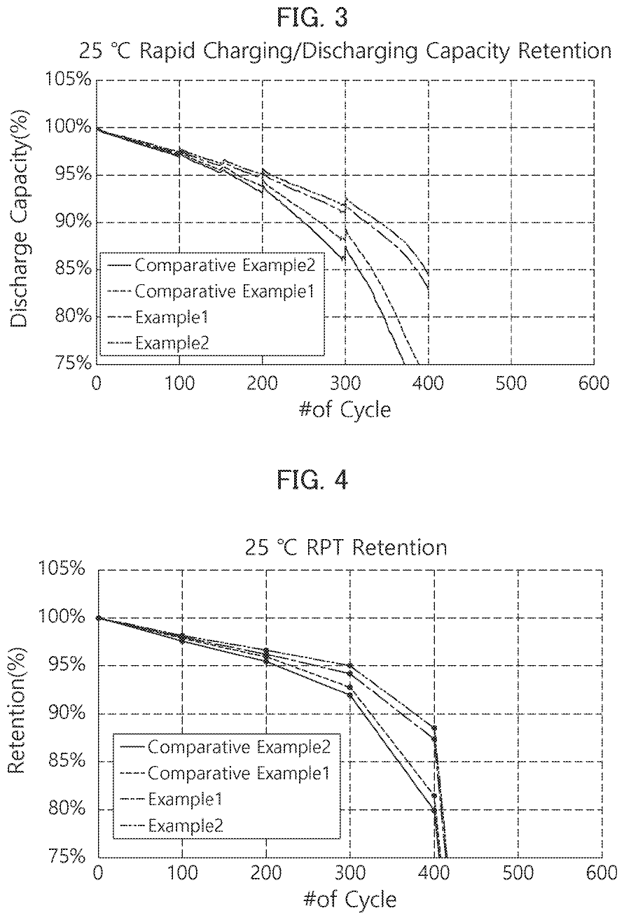

FIG. 3 is a graph showing a rapid charging/discharging capacity retention according to cycles of Example 1, Example 2, Comparative Example 1 and Comparative Example 2. FIG. 4 is a graph showing reference performance test (RPT) results according to cycles of Example 1, Example 2, Comparative Example 1 and Comparative Example 2.

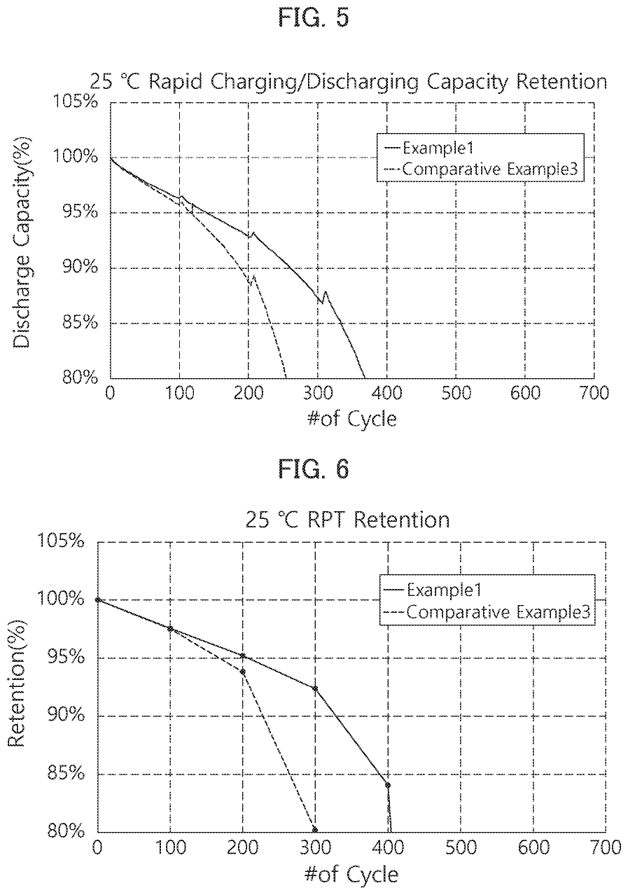

FIG. 5 is a graph showing a rapid charging/discharging capacity retention according to cycles of Example 1 and Comparative Example 3. FIG. 6 is a graph showing 35-minute rapid charging RPT results according to cycles of Example 1 and Comparative Example 3.

Based on FIGS. 4 and 6, RPT discharge capacity retentions in Examples and Comparative Examples are shown in Table 2 below.

TABLE 2

| | RPT discharge capacity retention after 400 cycles (%) |
|---|---|
| Example 1 | 87.3 |
| Example 2 | 88.5 |
| Comparative | 81.4 |
| Example 1 | |
| Comparative | 79.8 |
| Example 2 | |
| Comparative | 59.6 |
| Example 3 | |

Referring to Table 2 and FIGS. 3 to 6, improved rapid charging life-spans were obtained in Examples 1 and 2 while suppressing reduction of the discharge capacity due to the cycle repetition.

In Comparative Example 1 where the electrolyte solution did not contain ethyl acetate and Comparative Example 2 where the electrolyte solution did not contain ethyl acetate and LiFSI, the life-span properties during the rapid charging and discharging were degraded.

In Comparative Example 3 where the anode active material included an excessive amount of the silicon-carbon composite, the capacity retention and life-span properties were remarkably degraded.

What is claimed is:

1. A lithium secondary battery, comprising:
a cathode including a cathode active material that includes a lithium metal oxide;
an anode facing the cathode and including an anode electrode active material that includes a graphite-based active material and a silicon-carbon composite; and
an electrolyte solution including a lithium salt and an organic solvent, the lithium salt including lithium bis(fluorosulfonyl)imide (LiFSI) and the organic solvent including an acetate-based solvent,
wherein a content of the silicon-carbon composite is in a range from 5 wt % to 12 wt % based on a total weight of the anode active material.

2. The lithium secondary battery according to claim 1, wherein the content of the silicon-carbon composite is in a range from 7 wt % to 11 wt % based on the total weight of the anode active material.

3. The lithium secondary battery according to claim 1, wherein the silicon-carbon composite includes SiC.

4. The lithium secondary battery according to claim 1, wherein a weight ratio of the graphite-based active material and the silicon-carbon composite is in a range from 88:12 to 95:5.

5. The lithium secondary battery according to claim 1, wherein the graphite-based active material includes natural graphite or artificial graphite.

6. The lithium secondary battery according to claim 1, wherein a concentration of LiFSI in the electrolyte solution is in a range from 0.1 M to 1.0 M.

7. The lithium secondary battery according to claim 1, wherein a concentration of LiFSI in the electrolyte solution is in a range from 0.6 M to 0.9 M.

8. The lithium secondary battery according to claim 1, wherein a content of the acetate-based solvent is in a range from 5 vol % to 20 vol % based on a total volume of the organic solvent.

9. The lithium secondary battery according to claim 1, wherein a lithium salt further includes lithium hexafluorophosphate (LiPF₆).

10. The lithium secondary battery according to claim 9, wherein a molar concentration of LiPF₆ in the electrolyte solution is in a range from 0.1 M to 1.0 M.

11. The lithium secondary battery according to claim 9, wherein a molar concentration ratio of LiFSI and LiPF₆ in the electrolyte solution is in a range from 1:0.5 to 1:3.

12. The lithium secondary battery according to claim 1, wherein the acetate-based solvent includes at least one selected from the group consisting of methyl acetate, ethyl acetate and propyl acetate.

13. The lithium secondary battery according to claim 1, wherein the organic solvent further includes at least one carbonate-based solvent selected from the group consisting of propylene carbonate, ethylene carbonate, diethyl carbonate, dimethyl carbonate, ethylmethyl carbonate, methylpropyl carbonate, dipropyl carbonate and vinylene carbonate.

14. The lithium secondary battery according to claim 1, wherein the electrolyte solution further includes at least one additive selected from the group consisting of a carbonate-based compound substituted with a halogen group, a sulfone-based compound, a sulfite-based compound, a sulfonate-based compound, a sultone-based compound and a sulfate-based compound.

15. The lithium secondary battery according to claim 1, wherein the cathode active material includes a lithium-nickel metal oxide containing 80 mol % or more of nickel of all elements excluding lithium and oxygen.

16. The lithium secondary battery according to claim 1, further comprising a separator interposed between the cathode and the anode.
